(19) United States
(12) Patent Application Publication
(10) Pub. No.: US 2005/0067792 A1
(43) Pub. Date: Mar. 31, 2005

(54) Dough dropper

(76) Inventor: Linda Pulik, Chicago, IL (US)

Correspondence Address: OLSON & HIERL, LTD., 36th Floor, 20 North Wacker Drive, Chicago, IL, 60606, US

(21) Appl. No.: 10/673,079

(22) Filed: Sep. 26, 2003

(51) Int. Cl. F16J 15/18

(52) U.S. Cl. 277/514

(57) ABSTRACT

A dough dispenser is provided that has an elongated stem body terminating in a dome configured cavity with a downwardly opening mouth. The upper end of the stem body is associated with a reciprocally moveable plunger body. The stem body holds a subassembly of spirally extending shaft, base block and finger that extends downwardly from the base block and into and along side wall portions of the cavity. A biasing spring urges the plunger body into an upward position. When the plunger body is depressed into the stem body, a driver disk fixed to the plunger body slidably moves over the shaft and causes the base block and finger to rotate. The finger wipes cavity surfaces and releases dough therefrom.

### FIELD OF THE INVENTION

The present invention relates to dough dispensers and, in particular, to dough dispensers which include a dough separator finger for separating dough from a dispenser cavity.

### BACKGROUND OF THE INVENTION

When depositing amounts or dollops of cookie dough onto a cookie sheet prior to baking, it is usually desirable to make the amounts of dough deposited on the sheet uniform so that the resulting cookies are about the same size. In a domestic kitchen, an individual simply uses hand separation perhaps with a spoon and visual estimation of size to deposit individual dough dollops upon a cookie sheet. Depending on the experience of individual, variations in size of the resulting baked cookies can occur.

Commonly, cookie dough adheres to dispensing tools making it difficult to separate the dough from the tool and effectively aggravating the problem of depositing uniform dough dollops onto a cookie sheet. Time and material are often wasted in the process.

A hand-operated tool which would enable one to deposit about the same amount of cookie dough for each cookie from a dough batch onto a cookie sheet, and which would enable one to separate rapidly and conveniently with no waste the dough from the tool for direct deposit upon a cookie sheet would be desirable. However, a satisfactory tool for such purposes has not previously been available.

The present invention is directed to providing such a tool.

### SUMMARY OF THE INVENTION

More particularly, the present invention provides a dropper for cookie dough and the like. The dough dropper has a cavity which can be charged (filled) with an amount of dough. The dough dropper can then be moved to an adjacent but preferably somewhat elevated position over a selected location on a cookie sheet. While the dough dropper is supported by one hand, the other hand operates a plunger. As a result, the dough is discharged from the dough dropper while the surface portions of the dough dropper cavity are systematically swept by a separator finger that separates the dough from the cavity and allows the dough to separate from the cavity and deposit upon the cookie sheet.

By repeating the step sequence, dollops of dough each of substantially equal size can be progressively and relatively rapidly deposited upon the cookie sheet. Contact between the operator's fingers and the cookie dough is minimized and even completely avoided.

In a preferred form, the dough dropper comprises an elongated, generally hollow body stem that defines at its lower end an open bottomed, dome configured cavity. The opposed upper end of the body stem receives therein an elongated plunger arm that terminates at its upper end in a knob. The dough dropper internally is spring biased so that knob is maintained normally in an upwardly extended position relative to the body stem upper end. When the knob is downwardly compressed relative to the body stem, the plunger moves downwardly and axially into the body stem. As the plunger so moves, a separator finger on the exterior surface of the cavity slidably moves over and adjacent to the cavity surfaces along an arcuate path. Preferably, the finger rotates through about 360° as the plunger arm descends until the knob is near to the upper end of the body stem. The rotational movement of the separator finger functions to separate and release dough contained in the dome configured cavity so that when the cavity is normally located over a cookie sheet, the dough upon release from the cavity drops onto the cookie sheet.

To achieve the movement of the sliding finger, the finger extends axially upward through the apex of the cavity into engagement with a base support which is also associated with a spirally extending, ribbon-like, drive shaft. The drive shaft extends through and thus is associated with a driver disk fixed across the mouth of the plunger. Rotational movements of the plunger relative to the body stem are prevented. Thus, as the knob is depressed and the plunger descends into the base support, the drive shaft is caused to rotate relative to the driver disk resulting in rotation of the separator finger.

The dough dropper is simple, reliable and economical to fabricate, particularly when the plunger, knob and driver disk assembly, and also the body stem, are fabricated of molded plastic components.

The dough dropper provides an accurate, easily operated, kitchen tool not only for placing uniform amounts of cookie dough on a cookie sheet, but also for separating dough from a measuring or transferring cavity.

The dough dropper is well adapted for fabrication of components comprised largely of plastic with relatively few moving parts. In addition, the dough dropper is easy to cleanse, operate and store.

Other and further objects, aims, features, purposes, advantages, embodiments, variations and the like will be apparent to those skilled in the art from the present specification taken with the associated drawings and the appended claims.

### BRIEF DESCRIPTION OF THE DRAWINGS

In the drawings:

FIG. 1 is a perspective view of a preferred embodiment of the present invention;

FIG. 2 is a right side elevational view of the embodiment shown in FIG. 1;

FIG. 3 is a left side elevational view of the embodiment shown in FIG. 1;

FIG. 4 is a top plan view of the embodiment shown in FIG. 1;

FIG. 5 is a bottom plan view of the embodiment shown in FIG. 1;

FIG. 6 is a front side elevational view of the embodiment shown in FIG. 1;

FIG. 7 is a back side elevational view of the embodiment shown in FIG. 1;

FIG. 8 is an exploded, partially disassembled perspective view of the FIG. 1 embodiment;

FIG. 9 is a fragmentary detail view showing in side elevation the lower end of the FIG. 1 embodiment illustrating the start of the operation of depositing a dough dollop upon a cookie sheet, some parts thereof being broken away and some parts thereof being shown in section;

FIG. 10 is a bottom plan view similar to FIG. 5, but illustrating operation of the sliding finger during the sequence shown in FIG. 9;

FIG. 11 is a view similar to FIG. 9 illustrating the embodiment at the end of a dough dollop depositing operation;

FIG. 12 is an axial longitudinal sectional view taken through the embodiment of FIG. 1 with the plunger subassembly being in a fully upwardly extended configuration;

FIG. 13 is a view similar to FIG. 12 but showing the embodiment with the plunger subassembly being in a fully depressed configuration;

FIG. 14 is an exploded view similar to FIG. 8 but showing the embodiment in a fully dissembled configuration;

FIG. 15 is an enlarged, fragmentary, detail view taken through the mouth region of the plunger subassembly illustrating the manner in which the mouth region fixedly associates with the driver disk; and

FIG. 16 is a transverse sectional view taken through the FIG. 1 embodiment along the line XVI-XVI of FIG. 8.

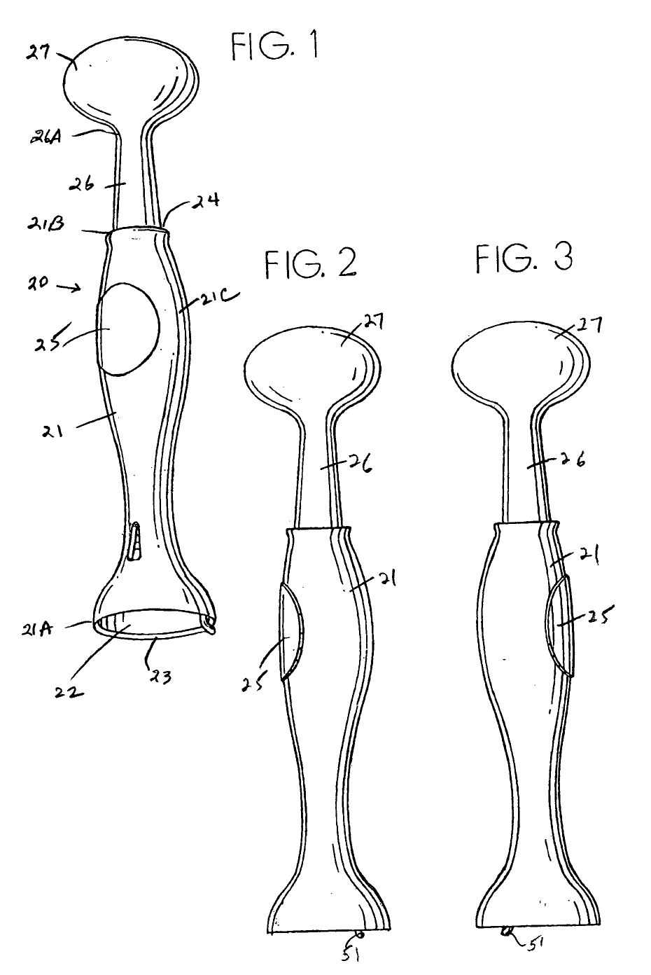

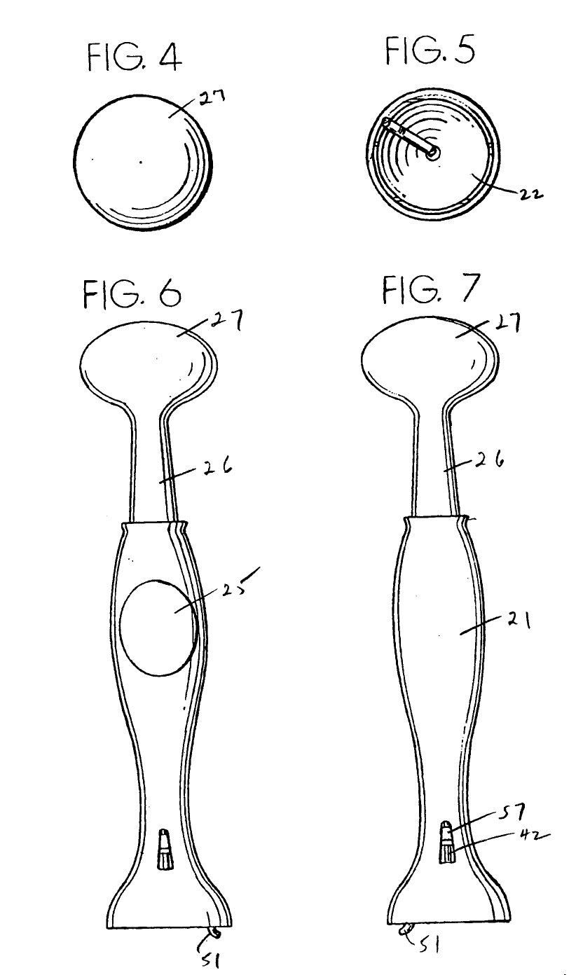

### DETAILED DESCRIPTION

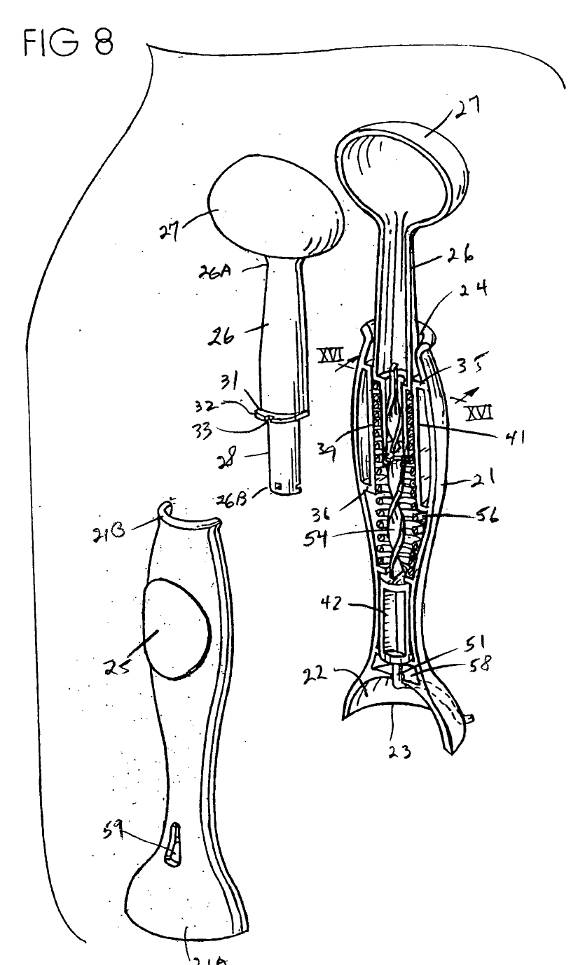

Referring to the drawings, there is seen a presently preferred embodiment 20 of a dough dropper of the invention. The dough dropper 20 includes an elongated, generally hollow stem body 21 having opposed lower and upper ends 21A and 21B, respectively. The lower end 21A defines a flared, walled, generally dome-configured cavity 22 (see, for example, FIG. 8) that has a downwardly opening mouth 23. The upper end 21B defines an upwardly opening channel aperture 24. Conveniently and preferably, the stem body 21 is comprised of two longitudinally matingly engageable halves of molded plastic which in the assembled dough dropper 20 are bonded together longitudinally and continuously by an adhesive, ultrasonic welding, or the like. To provide convenient grasping in the palm of one hand of a user, an upper elongated body portion of the stem body 21 is transversely enlarged to provide a thickened or bulged region 21C that is slightly asymmetrical radially, as shown. Also to enhance grasping capability, a slightly raised area 25, here illustrated to be elliptically shaped, is defined on an outer surface region of the bulged region 21C.

The dough dropper 20 further includes an elongated cylindrical plunger body 26 having an upper proximal end 26A and a lower distal end 26B. The upper proximal end 26A terminates in a knob 27, and the lower distal end 26B (see, for example, FIG. 8) defines along and longitudinally adjacent thereto a constricted cylindrical plunger lower body region 28. Conveniently and preferably, the plunger body 26 is comprised of two longitudinally matingly engageable halves of molded plastic which in the assembled dough dropper 20 are bonded together longitudinally and continuously by an adhesive, ultrasonic welding, or the like. The distal end 26B of plunger body 26 is provided terminally with a transversely oriented driver disk 29 (see, for example, FIG. 15). Preferably, the driver disk 29 is flattened, comprised of molded plastic, and separately formed. The driver disk 29 is conveniently provided with a plurality of radially outwardly extending flanges 30, here preferably four, that are each adapted to matingly engage a different opening 34 defined in the side wall of the lower body 28 at distal end 26B, thereby preventing rotation of the driver disk 29 relative to the plunger body 26.

The distal end 26B and adjacent portions of the plunger body 26 extend into the body of the stem body 21 through the channel aperture 24. The plunger body 26 is longitudinally reciprocatable relative to the stem body 21.

The stem body 21 and the plunger body 26 include cooperating means for limiting the location and the extent of longitudinal movement of the plunger body 26 relative to the stem body 21 and for preventing rotational movement of the plunger body 26 relative to the stem body 21. As those skilled in the art will readily appreciate, such cooperating means can be variously embodied.

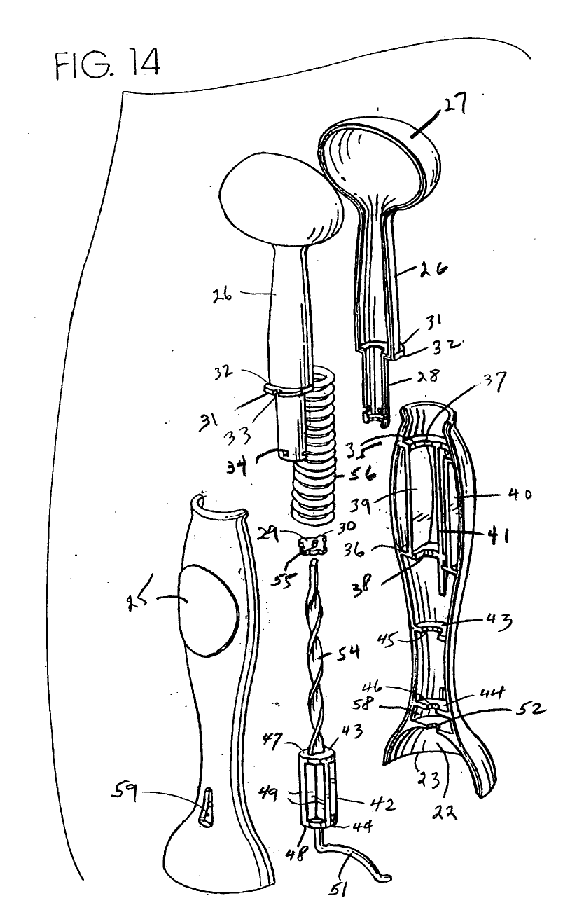

In the dough dropper 20, the plunger body 26 is provided with a circumferentially extending baffle plate 31 at the upper end region of the constricted plunger lower body portion 28. The baffle plate 31 serves to join the upper end portion of the body portion 28 with the plunger body 26; and the baffle plate 31 has a pair of circumferentially flattened, opposing side edge regions 32 (see, for example, FIG. 14) that extend parallel to each other and that are each substantially tangential to adjacent localized surface areas of the plunger body 26. The baffle plate 31 also has a pair of opposing notches 33 (see, for example, FIG. 14) that are each defined in an outer edge portion of the baffle plate 31 and located medially between the side edge regions 32. The baffle plate is preferably integrally formed with the plunger body 26 portions.

An upper internal region of the stem body 21, a pair of longitudinally spaced, parallel, transversely extending bulkheads 35 and 36 are provided (see, for example, FIG. 14) across the interior of the stem body 21, each bulkhead having a relatively large central channel 37 and 38, respectively, defined therethrough. Between the bulkheads 35 and 36 extend a pair of laterally spaced, parallel longitudinally extending guide walls 39 and 40. Medially and longitudinally located between the guide walls 39 and 40 and upstanding from the interior surface portions of the stem body 21 is a pair of opposed ribs 41 that each extend between the bulkheads 35 and 36. The bulkheads 35, 36, the guide walls 39, 40, and the ribs 41 are preferably each integrally formed with the stem body portions.

The interrelationship between components is such that during assembly of the dough dropper 20, the baffle plate 31 is positioned between the bulkheads 35, 36, each of the opposing side edges 32 is located adjacent a different one of the guide walls 39, 40, and each of the notches 33 is engaged with a different one of the ribs 41. Thereby, in the assembled dough dropper 20, the plunger body 26 can move reciprocatingly relative to the stem body 26 without rotational movement of the plunger body 26 relative to the stem body 26 while longitudinal movements of the plunger body 26 relative to the stem body 26 are limited by abutting engagement of the baffle plate 31 with one or the other of the bulkheads 35, 36.

Located in a region of the stem body 21 above and in adjacent relationship to the cavity 22 is a rotatable base block 42. To prevent the base block 42 from moving longitudinally in the stem body 21, the stem body 21 is provided over each end of the base block 42 with a pair of longitudinally spaced, transversely extending, parallel bulkheads 43 and 44, each bulkhead 43, 44 having a relatively large central channel 45 and 46, respectively, defined therethrough. Various arrangements for positioning and locating the base block 42 can be used. For example, the bulkhead 44 can be eliminated and the base block 42 lower end allowed to be adjacent to the apex region of the wall of the cavity 22.

The base block 42 can be variously configured and structured, but here the base block 42 is comprised of molded plastic and includes an upper circular end plate 47 and a lower circular end plate 48 that are interconnected together in spaced, parallel relationship to one another by four circumferentially spaced, longitudinally extending centrally interjoined ribs 49 unitarily interconnected together.

Seated centrally in the lower end plate 48 of the base block 42 is one end of a rigid sliding finger 51. The finger 51 projects downwardly and axially through the bulkhead 44 and through an opening 52 in the apex of the wall of the cavity 22. Thereafter, the finger 51 is configured to extend adjacently and slidably over localized surface portions that define the cavity 22, and the finger 51 has an opposite end which terminates adjacent to the mouth 23. Preferably, and as shown, the finger 51 opposite end partially overlaps and slidably moves over lip portions of the mouth 23.

Seated centrally in the upper end plate 47 of the base block 42 is one end of a longitudinally straight but spirally twisted drive shaft 54 which in transverse section is generally rectangularly shaped so that the shaft 54 has opposed, flattened, side faces. The opposite end of the drive shaft is extended slidably through a mating central orifice 55 defined in the driver disk 29.

Spring biasing means, which in the dough dropper 20 is preferably a coiled spring 56 that resists compression, is preferably provided, as shown. The spring 56 encircles the drive shaft 54 and surrounds the cylindrical lower body portion 28 of the plunger body 26. The upper end portion of the spring 56 abuts against the baffle plate 31 and the lower end portion of the spring 56 abuts against the bulkhead 43. Alternative arrangements may be used, if desired. The spring biasing means functions to yieldingly urge the plunger body 26 into an uppermost extended position relative to the stem body 21.

In the assembled dough dropper 20, when the plunger body 26 is moved longitudinally downwards relative to the lower end 21A by means of manual pressure applied by one hand of a user to the knob 27 while the other hand grasps the stem body 21, the driver disk 29 slides over local portions of the drive shaft 54. Thereby, the drive shaft 54 is caused to rotate, thereby rotating the base block 42 and the sliding finger 51. The sliding finger 51 slidably moves progressively over local surface portions of the cavity 22 whereby dough contained in the cavity 22 is separated and released as when the dough dropper 20 is positioned spatially over and adjacent to a cookie sheet. Return upwards of the plunger body 26 under bias force from spring 56 causes rotation of the sliding finger 51 in a reverse direction.

Preferably, the number of twists provided in the drive shaft 54 is sufficient to cause the sliding finger 51 to rotate through about 360° and travel over the entire surface area of the cavity 22 when the plunger body 26 is longitudinally moved from a fully upwardly extended position to a fully compressed lower condition relative to the stem body 21.

In the preferred embodiment 20, where the bulkhead 44 is spaced from but adjacent to the apex of the wall of the cavity 22, so that a small chamber 58 exists between the bulkhead 44 and the cavity 22 wall, a window 59 is defined in the stem body 21 wall adjacent the chamber 58 whereby water or the like can be charged to the chamber 58 through the window 59 for purposes of flushing and cleansing of the dough dropper 20 after use.

Before the halves of the stem body 21 are secured together, the subassembly of plunger body 26 and driver disk 29, the subassembly of shaft 54, base block 42, sliding finger 51, and the spring 56 are positioned in one of the stem body 21 halves in an operable configuration.

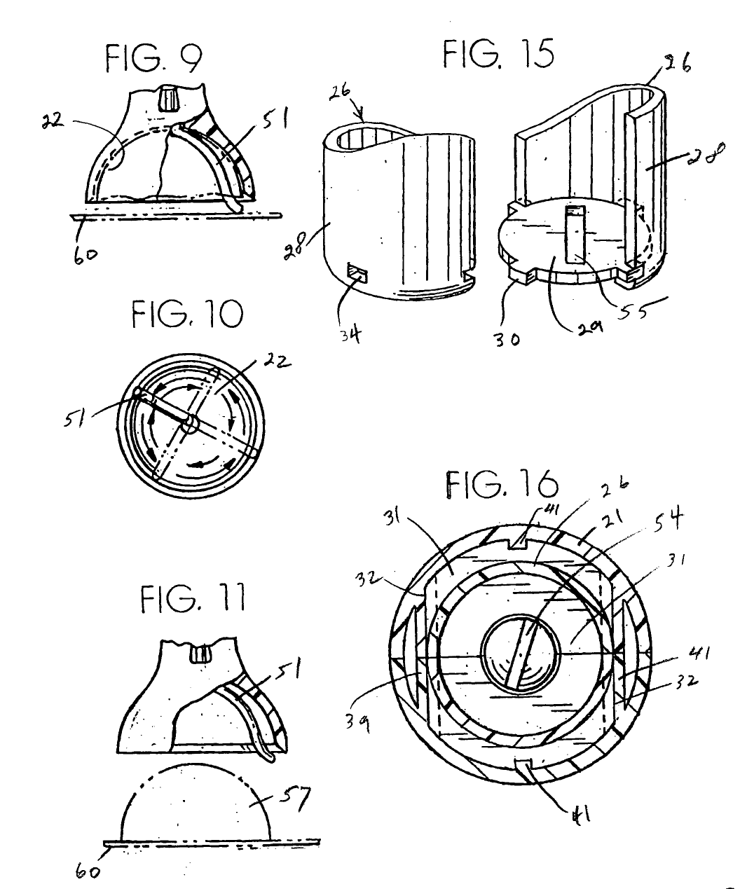

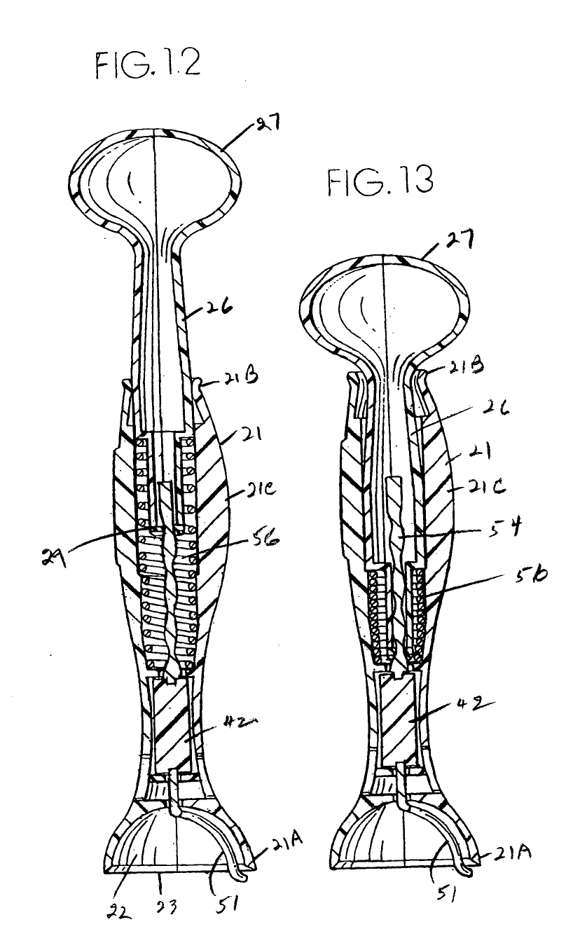

The invention can be considered to relate to a process for transferring cookie dough or the like from a dough batch and dropping regulated amounts of the dough, such as a dollop 57, upon a cookie sheet 60 for baking or the like. The process, which is partially and illustratively shown in the sequence of FIGS. 9-11, the movement of the sliding finger 51 over surface portions of the cavity 22 being shown in FIG. 10, comprises the steps of first filling the cavity 22 with cookie dough, positioning the mouth 23 of the cavity 22 over a cookie sheet in a desired location while holding the stem body 21 preferably with one hand, and depressing (pushing) the knob 27 downwards whereby the plunger body 26 descends into the stem body 21. The sliding finger 51 progressively and slidably advances over surface portions of the cavity 22 and the dough in the cavity 22 is released from the cavity 22 and deposited upon the cookie sheet. The process steps are sequentially and successively repeated to a desired extent; for example, until the cookie sheet is filled with dough dollops released from the dough dropper 20.

Other and further embodiments, applications, features and the like will be apparent to those skilled in the art.

It is to be understood that the invention is not limited to the particular structures and methods shown and described, and that changes and adaptations are contemplated which readily and fairly fall within the spirit and scope of the invention as set forth and determined by the appended claims.

1. A dough dropper comprising in combination:
an elongated stem body terminating in a cavity with a mouth;
a plunger body reciprocally associated with the stem body;
a base block rotatably associated with the stem body, said base block having relative thereto an upwardly axially extending spiral shaft that slidably associates with the plunger body and a downwardly extending finger that extends slidably over side wall portions of the cavity when the base block rotates;
whereby reciprocation of the plunger body relative to said stem body causes the spiral shaft to rotate and the finger to move slidably over the cavity side wall portions.

2. The dough dropper of claim 1 which includes a biasing spring for urging the plunger body into extended position relative to the plunger body.

3. A dough dropper comprising in combination an elongated stem body terminating in a dome configured cavity with a downwardly opening mouth, the upper end of the stem body being associated with a reciprocally moveable plunger body, the stem body holding a subassembly of spirally extending shaft, base block and a finger that extends downwardly from the base block and into and along side wall portions of the cavity, a biasing spring urging the plunger body into an upward position, whereby, when the plunger body is depressed into the stem body, a portion of the plunger body slidably moves over the shaft and causes the base block and finger to rotate and thereby wipes cavity surfaces and releases dough therefrom.

4. The dough dropper of claim 3 wherein the stem body and the plunger body are each comprised of molded plastic.

5. The dough dropper of claim 3 wherein the portion of the plunger body that so slidably moves over the shaft is a driver disk fixed to the lower end of the plunger body.

6. A dough dropper comprising in combination:
an elongated stem body having a lower end and an upper end, the lower end terminating in a dome configured cavity with a downwardly opening mouth;
an elongated plunger body having a proximal end and a distal end, the lower end being reciprocally and longitudinally movable through the upper end relative to the stem body;
the stem body holding a base block that is rotatable relative to the stem body, the base block having a spirally extending shaft upwardly projecting from the block axis, and the base block having a downwardly extending finger that extends into and along side wall portions of the cavity;
a portion of the plunger body being associated with the shaft and longitudinally slidable therealong; and
a biasing spring for urging the plunger body into an upward position relative to the stem body;
whereby, when the proximal end of the plunger body is moved towards the stem body, the distal end of the plunger is depressed into the stem body, and the plunger body slidably moves over the shaft and causes the base block and finger to rotate and thereby wipes cavity surfaces and releases dough therefrom.

7. The dough dropper of claim 6 wherein the portion of the plunger body so slidably associated with the shaft is a driver disk that is fixed to the distal end of the plunger body.

8. A dough dropper comprising in combination:
an elongated, generally hollow stem body having opposed lower and upper ends, said lower end defining a flared, walled, generally dome configured cavity that defines a downwardly opening mouth, and said upper end defining an upwardly opening channel aperture;
an elongated plunger body having an upper proximal end and an opposed lower distal end, said proximal end terminating in a knob, and said distal end defining longitudinally adjacent thereto a constricted plunger lower body region and having a terminal driver disk, said distal end extending into said stem body through said upwardly opening channel;
said plunger body being longitudinally reciprocal relative to said stem body, and said plunger body and said stem body including cooperating means for limiting the extent of longitudinal movement of said plunger body relative to said stem body and including cooperating means for preventing rotational movement of said plunger body relative to said stem body;
said stem body holding internally adjacent said cavity a rotatable but longitudinally immovable base block and including means associated with said stem body for so holding said base block, said base block having opposed upper and lower end portions;
said base block having one end of a rigid sliding finger fixed centrally at its lower end portion, said rigid finger
projecting axially downwardly through and into said walled cavity,
extending adjacently and slidably over localized surface portions defining said cavity, and
having an opposed end terminating adjacent to said mouth;
said base block further having one end of a straight extending, spirally twisting drive shaft with opposed flattened side faces fixed centrally at its upper end portion, said drive shaft having an opposed end extending through said terminal driver disk;
spring biasing means retained in said stem body between said base block and said plunger body and extending circumferentially around said constricted plunger lower body region for yieldingly urging said plunger body axially upwardly relative to said stem body;
whereby, when said plunger body is moved longitudinally relative to said stem body, said driver disk slides over local portions of said drive shaft and rotates said drive shaft, said base block and said sliding finger, thereby slidably moving said sliding finger over said surface portions of said cavity and separating dough contained in said cavity from said cavity.

9. The dough dropper of claim 8 wherein the number of twists along said drive shaft are such as to cause said sliding finger to rotate through about 360° over said surface portions when said plunger body is longitudinally moved from a fully extended position to a fully compressed condition relative to said stem body.

10. The dough dropper of claim 8 wherein said spring biasing means is a coiled spring that resists compression and said spring normally encircles said drive shaft and said constricted plunger lower body region of said plunger body.

11. The dough dropper of claim 8 wherein said stem body is enlarged adjacent to said upper end to facilitate hand grasping.

12. The dough dropper of claim 8 wherein a first bulkhead supports said lower end portion of said base block in adjacent, spaced relationship relative to said cavity and said sliding finger extends from said base block through said first bulkhead and into said cavity.

13. The dough dropper of claim 12 wherein a chamber exists in said stem body between said first bulkhead and the adjacent wall portion of said cavity, and wherein a window is defined in said stem body accessing said chamber whereby said chamber can be flushed with water or the like in cleaning said dough dropper.

14. The dough dropper of claim 12 wherein a second bulkhead supports said upper end portion of said base block and said second bulkhead and said first bulkhead cooperate to allow said base block to rotate therebetween but not to move longitudinally in said stem body.

15. The dough dropper of claim 8 wherein said base block is comprised of molded plastic and includes an upper end plate and a lower end plate interconnected together by four circumferentially spaced longitudinally extending, centrally joined ribs.

16. The dough dropper of claim 8 wherein said stem body is comprised of two longitudinally matingly engageable halves of molded plastic which when assembled are bonded together by an adhesive means.

17. The dough dropper of claim 8 wherein said plunger body is comprised of two longitudinally matingly engageable halves of molded plastic which when assembled with said driver disk are bonded together by an adhesive means.

18. The dough dropper of claim 17 wherein said driver disk is comprised of plastic and is provided with a plurality of peripherally projecting, equally circumferentially spaced flanges which engage matingly holes defined adjacent the distal end portion of said plunger body.

19. The dough dropper of claim 8 wherein said plunger body has:
a baffle plate circumferentially extending therearound at the upper end region of said constricted plunger lower body region, and
said baffle plate has flattened opposing side regions that extend parallel to each other, and also has a pair of opposing notches defined in edge portions thereof located medially between said opposing side regions, and wherein an upper region of said stem body has defined therein
a pair of laterally spaced, parallel, longitudinally extending guide walls with
a pair of longitudinally extending opposed ribs defined therein located medially between said guide walls, and
a pair of bulkheads, each one located at a different end of said guide walls and said ribs, and
wherein said baffle plate is positioned between said pair of bulkheads, each of said opposing side regions is adjacent a different one of said guide walls, and each of said notches engages a different one of said opposed ribs whereby said plunger body can reciprocatingly move relative to said stem body without rotational movement.

20. The dough dropper of claim 8 wherein said sliding finger, said shaft, and said spring are each comprised of metal.

21. A process for transferring with a dough dropper cookie dough from a dough batch and dropping regulated amounts of said dough upon a cookie sheet for baking, the dough dropper comprising in combination an elongated stem body terminating in a cavity with a mouth, a plunger body reciprocally associated with the stem body, a base block rotatably associated with the stem body, the base block having relative thereto an upwardly axially extending spiral shaft that slidably associates with the plunger body and a downwardly extending finger that extends slidably over side wall portions of the cavity when the base block rotates; whereby a reciprocation of the plunger body relative to the stem body causes the spiral shaft to rotate and the finger to move slidably over the cavity side wall portions, the process comprising the steps of:
(a) filling the cavity of the dough dropper with cookie dough;
(b) positioning the cavity mouth over a cookie sheet while holding the stem body; and
(c) reciprocating the plunger body relative to the stem body whereby the sliding finger moves over surface portions of the cavity and the dough in the cavity is released from the cavity and deposited upon the cookie sheet.

22. The process of claim 21 wherein said steps (a) through (c) are successively repeated.
